(19) United States
(12) Patent Application Publication
(10) Pub. No.: US 2015/0144611 A1
(43) Pub. Date: May 28, 2015

(54) FURNACE AND METHOD FOR OPERATING A FURNACE

(71) Applicant: Redios-Tec GmbH, Freilassing (DE)

(72) Inventor: Stephan Miller, Traunstein (DE)

(21) Appl. No.: 14/400,483

(22) PCT Filed: May 8, 2013
(86) PCT No.: PCT/EP2013/059626

§ 371 Date: Nov. 11, 2014

(30) Foreign Application Priority Data
May 11, 2012 (DE) 10 2012 207 897.5

(51) Int. Cl. F27B 17/02; A61C 13/20; F27D 21/00; F27D 19/00

(52) U.S. Cl. CPC F27B 17/025; F27D 19/00; A61C 13/20; F27D 21/00; F27D 2021/0057
USPC 219/413

(57) ABSTRACT

The invention relates to a furnace for firing products to be fired, in particular dental ceramics, comprising a control unit for controlling the furnace. The control unit has a release portion which can be activated be means of an individualized control command, in particular be means of an encoded activation code. The release portion is designed such that one or more firing processes can be carried out in an activated state of the release portion and no firing processes can be carried out in a deactivated state of the release portion.

The present invention relates to a furnace for firing products to be fired, in particular dental ceramics.

The furnace includes a control unit for controlling the furnace. The control unit has an enabling section which can be activated by means of an individualized control instruction, in particular by means of an encoded activation code. The enabling section is configured such that, in an activated state of the enabling section, the carrying out of one or more firing processes is possible and such that, in a non-activated state of the enabling section, the carrying out of a firing process is not possible.

It is, for example, ensured by the enabling section that only an authorized user can operate the furnace. In a non-activated state, the enabling section in particular also admittedly allows an at least partial operation of the control unit; a carrying out of a firing process is, however, suppressed in this state.

The control instruction can include device-specific information so that it only effects an activation of the enabling section with a specific furnace. It is, for example, conceivable that the control instruction includes a clear device identification or clearly refers to it. It is thereby reliably prevented that a control instruction provided for a specific device is used without authorization or unintentionally with another furnace.

The control instruction can—additionally or alternatively—comprise information with respect to a predefined number of released firing processes. In other words, the control instruction in this embodiment includes an indication of how many firing processes should be enable by the activation code. For example, a manipulation-safe count variable can be provided in the enabling section which is set to a predefined value by the control instruction and which is decremented on each firing process.

The control instruction thus sets a kind of credit in the enabling section by the count variable. In this simplest case, independently of, for example, the duration and/or the temperature profile of the firing process, a respective fixed value is deducted from the count variable until the credit has been used up and the enabling section is deactivated. It is, however, also possible to reduce the credit in dependence on process parameters. I.e. the count variable is, for example, varied by different amounts in dependence on the duration, the achieved maximum temperature, a parameter reflecting the temperature profile and/or while taking account of other process parameters. It would accordingly then be possible to carry out a larger number of shorter firing processes than long firing processes with a specific credit.

The control information can include the information in any desired form—also encoded in the form of a code. In accordance with an embodiment, the control unit is connectable to a remote data transmission network such that the control instruction can be supplied to the enabling section via the remote data transmission network.

Alternatively or additionally, the control unit can have an image reading unit with which a pattern comprising the control instruction can be detected and with which the control instruction can be extracted from the pattern. The image reading unit in particular comprises a camera or a scanner.

The image reading unit is, for example, fixedly installed in or at the furnace. Provision can, however, also be made to connect at least one component of the image reading unit—for example a scanner—or the total image reading unit releasably—for example via a USB connection—or even wirelessly to the remainder of the control unit.

In accordance with a further embodiment, the control unit has an output section. A pattern can be output by the output section which includes information with respect to an operating state of the furnace and/or which includes information deposited or stored in the control unit. The pattern can, for example, include a one-dimensional, two-dimensional or three-dimensional code which includes the named information in encoded form. The output section is in particular a screen or a printer.

The invention further relates to a method of operating a furnace for firing products to be fired, in particular for firing dental ceramics. The method is in particular suitable for the operation of a furnace in accordance with at least one of the above-described embodiments. The furnace comprises a control unit having an enabling section which can be activated by means of an individualized control instruction, in particular by means of an encoded activation code. The enabling section is configured such that, in an activated state of the enabling section, the carrying out of one or more firing processes is possible and such that, in a non-activated state of the enabling section, the carrying out of a firing process is not possible. The control instruction is supplied to the enabling section to activate the enabling section so that the carrying out of a predefined number of firing processes is enabled.

As was already explained above in connection with the furnace in accordance with the invention, the control instruction can comprise device-specific information and/or information with respect to a number—possibly dependent on the process parameters—of enabled firing processes.

The control unit is in particular selectively connectable or permanently connected to a remote data transmission network. Provision can therefore be made that the control unit is generally constantly connected to the remote data transmission network if one excludes unforeseen interruptions and/or service interruptions. In a number of cases, it can, however, be sufficient if the control unit is only brought into contact with the remote data transmission network as required automatically or manually.

Remote data transmission networks within the context of the present invention are any kind of wired and/or wireless networks which allow the transmission of data. It can comprise a transmission of data within a building or over continents. The data transmission can take place, for example, via local networks (e.g. LAN, WLAN), via the internet and/or via the cellular network.

Provision can alternatively or additionally be made that a pattern including the control instruction is detected by means of an image reading unit associated with the control unit. The control instruction is in this case extracted from the pattern by the control unit and/or by the image reading unit. Such an image reading unit can in particular be provided in furnaces which are only connectable to a remote data transmission network with a relatively large effort. It is, however, also possible to provide the image reading unit as a redundant path for supplying the control instruction in order also to be able to supply a control instruction to the control unit with an interrupted remote data transmission network. A possibility for the manual input of the control instruction via a conventional keyboard or via a suitable touchscreen can also be provided.

To ensure that the furnace is always usable, a warning can be output by the control unit on the falling below of a threshold value of a number of firing processes which can still be carried out or of the above-described count variable and/or a demand for providing a new control instruction can be output. In other words, the control unit monitors whether the number of enabled firing processes or the corresponding credit has already been reduced so far that a deactivation of the enabling section is to be anticipated in the fairly near future. On the falling below of a corresponding threshold value which can possibly be freely set by the user, the control unit warns the user and/or generates a request with which a new control instruction can be requested.

The request can, for example, be transmitted via the remote data transmission network to a location which manages, outputs and/or generates the control instructions. Such a location is in particular the furnace manufacturer and/or a company which markets the corresponding furnaces. A check is made there whether the sender of the request is authorized to receive a new control instruction with which further firing processes can be carried out. A check is, for example, made whether the requester of the control instruction has paid a corresponding fee. The control instruction can then be generated while taking account of the identity of the sender of the request or of a parameter characterizing or identifying the corresponding furnace and can be sent to the sender of the request or can be otherwise provided, e.g. for a download. The control instruction is in particular configured so that it can only be used one single time.

Further embodiments of the invention are set forth in the dependent claims, in the description and in the enclosed drawing.

The invention will be described in the following purely by way of example with reference to advantageous embodiments and to the enclosed drawing.

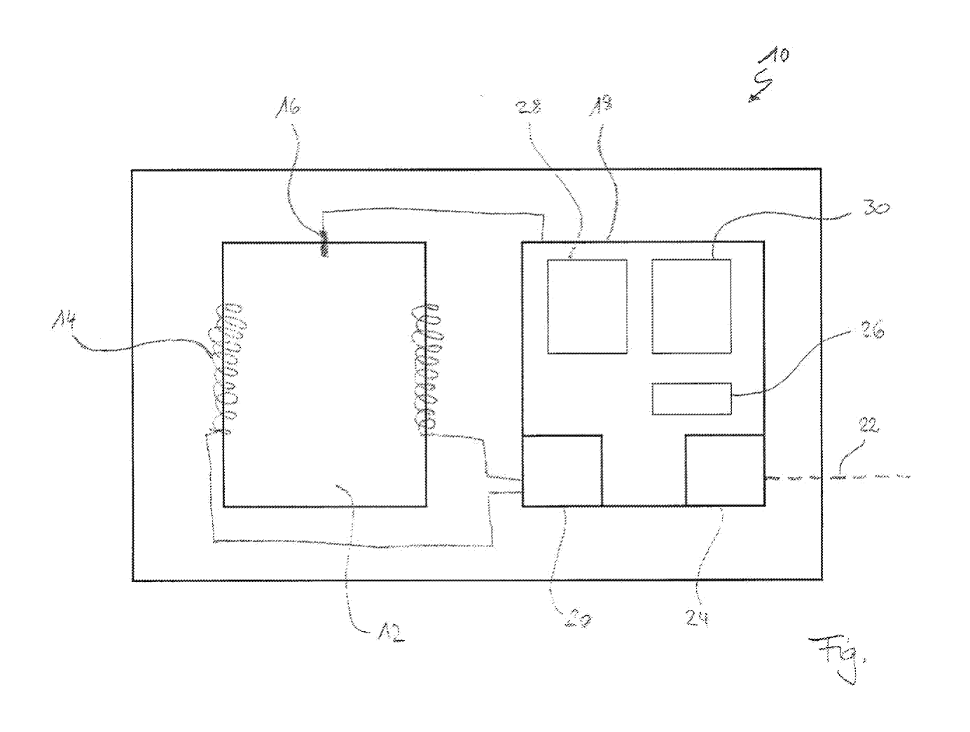

The only FIG. 1 shows a furnace 10 with a firing chamber 12 in which the product to be fired can be arranged. The temperature in the firing chamber 12 required for the respective firing process is generated by heating elements 14. The temperature present in the firing chamber 12 is measured by a temperature sensor 16.

The heating elements 14 and the temperature sensor 16 are connected to a control unit 18 which controls the operation of the furnace 10. The control unit 18 makes is possible to carry out different firing processes in which the temperature in the interior of the firing chamber 12 is varied in dependence on time in the desired manner. The time variation of the firing temperature in the interior of the firing chamber 12 is fixed by so-called firing programs which are worked through by the control unit 18.

The control unit 18 comprises an enabling section 20 which interrupts the control of the heating elements 14 as long as no contrary control instruction is present. It is also conceivable that the enabling section 20 intervenes in the operation of the furnace 10 at another point in order reliably to prevent the carrying out of firing processes.

The enabling section 20 allows the control of the heating elements 14 only when a corresponding activation code is present. It can, for example, be provided via a remote data transmission network 22 (RDT network) which is coupled to the control unit 18 via an interface 24. An RDT network in this connection is, for example, to be understood as a cellular network, the internet and/or a local network—e.g. a LAN, WLAN. In other words, activation codes which are processed in the control unit 18 can be supplied to the furnace 10 via a network connection of any desired configuration so that the carrying out of firing processes is possible.

The activation codes are in particular device-specific so that they only effect the enabling of further firing processes with very specific devices to prevent an unauthorized use of the activation codes. The activation codes can be encoded and can generally have any desired data format or encoding format. As required, the activation codes can also include further information in addition to the device-specific information such as information which reflects how many firing processes should be enabled.

It must be pointed out in this connection that provision can be made to take account of specific parameters of the firing processes—e.g. their duration, temperature profile, . . . —in the decrementing of the credit. For example, the enabling section is charged with a credit by the activation code from which an individually determined value is deducted for each firing process, with this value depending on certain parameters of the firing process. A differentiated price model can thereby be provided which takes account of the actual use of the furnace more exactly than a simple counting of firing processes carried out.

Provision can alternatively or additionally be made that the activation codes are input into the control unit 18 via an input unit 26, e.g. a keyboard.

Instead of the input unit 26 and/or of the connection to the RDT network 22 or in addition to the named components, an image reading device 28 can be provided with which a pattern can be taken which includes an activation code. Such a pattern can, for example, be a barcode or a two-dimensional matrix code. The image reading unit 28 is configured such that it can read out the information included in the code. This information forms the activation code for activating the enabling section 20.

A user orders the activation code, for example, orally, in writing or in an electronic manner to be able to use the furnace 10. After checking the authorization to use the furnace 10, which can be purchased, for example, by payment of a usage fee, the user is provided with a two-dimensional QR code which he holds in front of the image reading device 28 in printed form or as a graphic on a screen, for example on a screen of a cellular phone. The image reading device 28 takes the QR code and extracts the activation code contained therein which is in turn forwarded to the enabling section 20, whereupon the latter allow a current feed to the heating elements 14. The QR code can be provided by way of mail or electronically—for instance, as an image file by e-mail or via an internet link to be activated.

It is not necessary in this procedure that the furnace 10 is connected to the RDT network 22, which is associated with a cost saving as a rule. In contrast to this, a connection of the furnace to the RDT network 22 allows a direct feed of the activation code into the control unit 18. The ordering of the activation code can take place analog to the manner described in connection with the image reading device 28. The same applies to the ordering of activation codes to be input via the input unit 26.

It is possible by means of the enabling section 20—independently of the configuration of the activation code and/or of its transmission path—to realize the most varied usage and fee concepts. For example, the furnace 10 is sold to a customer at a specific basic price. The customer furthermore pays a basic fee at regular intervals, for example monthly, and in return has the possibility of carrying out a specific number of firing processes. If the number of firing processes covered by the basic fee has been carried out, the enabling section 20 recognizes this and blocks the carrying out of further firing processes. The customer can now purchase the authorization to carry out a further firing process or a specific number of firing processes. For this purpose, he contacts the manufacturer of the furnace 10 or its sales partner and orders an activation code for activating the furnace 10 by telephone, in writing or electronically.

It is generally also possible already to acquire an authorization for further firing processes before a blocking. The control unit 18 and/or the enabling section 20 are in particular configured such that it registers as soon as the enabled number of firing processes has almost been used up so that a new activation code can be requested in good time. The request can take place manually or even automatically. For example, the control unit 18 outputs a warning which causes the user to request a new activation code. It is, however, generally also possible that the control unit 18 transmits a request automatically with a link to the RDT network 22, whereupon a suitable activation code is generated and is sent to the user or even immediately to the control unit 18. On the generation of the activation code, a certain amount is billed to the user, for example. Provision can, however, also be made that the user is first asked for confirmation of the automatically prepared request before the generation of the activation code.

A QR code which includes an activation code can, for example, also be sent or made available to the customer. The QR code is taken and evaluated by the image reading device 28. I.e. the activation code contained in the QR code is extracted and then forwarded to the enabling section 20. As soon as the activation code has been supplied to the enabling section 20 and has been checked by it with a positive result, the enabling section 20 is activated so that the carrying out of a specific number of firing processes is permitted. For example, the activation code is generated very specifically for a specific furnace 10 so that it only effects an activation of the enabling section 20 for this furnace 10 and thus only effects an activation of the furnace 10.

For example, the QR code is provided on a specific internet page which can then be printed and held in front of the image reading device 28. It is also possible to access this internet page by means of a suitable cellular phone, a tablet computer or a similar device and to display the QR code stored there on the screen of the corresponding device. The screen is then held in front of the image reading device 28 and the QR code presented thereon is detected by it. A direct sending of the QR code to the device—e.g., as an image file—is also conceivable.

With a link of the furnace 10 to the RDT network 22, the most varied ways for transmitting an activation code to the control unit 18 are likewise conceivable. For example, a direct activation can take place wirelessly via a UMTS interface or cellular interface integrated in the furnace 10. A USB connection can also be provided via which an external interface—for example a suitable cellular phone, a tablet computer or a similar device—can be connected to the control unit 18. The customer then dials a specific telephone number—for example a telephone number specific to a furnace—and the activation code is transmitted to and via the connection established in this manner. The transmission in particular takes place automatically.

Additionally or alternatively to the above-described components, the furnace 10 can be provided with a display unit 30. The operating parameters of the furnace 10 are, for example, displaced on the display unit 30. The display unit 30 can, however, also be used to represent a code, for example a QR code, which can be photographed, for example, and which can subsequently be forwarded. For example, the represented code includes error information which can be utilized for the analysis of a malfunction of the furnace 10. The presented information can also include other information such as a content of a memory of the control unit 18 to be able to save the corresponding information or to use it in another manner. The code can also be output with the aid of a printer.

It is understood that firing programs which are stored in a database, for example, can also be provided to the control unit 18 in the above-described different manners instead of or in addition to the activation codes.

To prevent abuse, the enabling section 20 is particularly secured against manipulations. The enabling section 20 can generally be formed by a software module which is executed by a process of the control unit 18. The enabling section 20 can, however, also be a specific hardware component. A hardware/software combination is likewise possible to realize the enabling section 20.

### REFERENCE NUMERAL LIST

10 furnace
12 firing chamber
14 heating element
16 temperature sensor
18 control unit
20 enabling section
22 remote data transmission network
24 interface
26 input unit
28 image reading unit
30 display unit

1-15. (canceled)

16. A furnace for firing products there being a control unit (18) for controlling the furnace, the control unit (18) having an enabling section (20) which can be activated by means of an individualized control instruction the enabling section (20) being configured such that, in an activated state of the enabling section (20), the carrying out of one or more firing processes is possible; and such that, in a non-activated state of the enabling section (20), the carrying out of a firing process is not possible.

17. A furnace in accordance with claim 16, said products being dental ceramics.

18. A furnace in accordance with claim 16, said individualized control instruction being an encoded activation code,

19. A furnace in accordance with claim 16, the control instruction comprises device-specific information.

20. A furnace in accordance with claim 16, the control instruction comprising information with respect to a predefined number of enabled firing processes.

21. A furnace in accordance with claim 16, the control nit (19) being connectable to a remote data transmission network (22) such that the control instruction can be supplied to the enabling section (20) via the remote data transmission network (22).

22. A furnace in accordance with claim 16, the control unit (18) comprising an image reading unit (28) with which a pattern including the control instruction can be detected and with which the control instruction can be extracted from the pattern.

23. A furnace in accordance with claim 16, the control unit (18) having an output section (30) for outputting a pattern, the pattern including at least one of information with respect to an operating state of the furnace and information stored in the control unit (18).

24. A furnace in accordance with claim 23, the pattern being a two-dimensional pattern

25. A method of operating a furnace for firing products, there being a control unit (18) for controlling the furnace, the control unit (18) having an enabling section (20) which can be activated by means of an individualized control instruction, wherein the enabling section (20) is configured such that, in an activated state of the enabling section (20), it enables the carrying out of one or more firing processes; and such that, in a non-activated state of the enabling section (20), it inhibits the carrying out of a firing process, the control instruction being supplied to the enabling section (20) to activate the enabling section (20) such that the carrying out of a predefined number of firing processes is enabled.

26. A method in accordance with claim 25, the furnace being used for the firing of dental ceramics.

27. A method in accordance with claim 25, an encoded activation code being used for said individualized control instruction.

28. A method in accordance with claim 25, device-specific information being used for the control instruction.

29. A method in accordance with claim 25, information with respect to a number of enabled firing processes being used for the control instruction.

30. A method in accordance with claim 25, the control unit (18) being one of selectively connectable and essentially permanently connected to a remote data transmission network (22), the control instruction being supplied to the enabling section (20) via the remote data transmission network (22).

31. A method in accordance with claim 25, there being an image reading unit (20) associated with the control unit (18), the image reading unit detecting a pattern including the control instruction and the control instruction being extracted from the pattern by at least one of the control unit (18) and the image reading unit (28).

32. A method in accordance with claim 25, the control unit (18) outputs a warning when a number of firing processes which can still be carried out falls short of a threshold value.

33. A method in accordance with claim 25, the control unit (18) outputs a request for a provision of a new control instruction when a number of firing processes which can still be carried out falls short of a threshold value.

34. A method in accordance with claim 25, the control instruction being generated and being supplied to the enabling section (22) only on request and after checking of the request

35. A method in accordance with claim 34, the control instruction being generated automatically.

36. A method in accordance with claim 34 and being transmitted one of directly and indirectly to the enabling section (20).

37. A method in accordance with claim 25, a request for the provision of a control instruction being sent to a location adapted to send control instructions via a remote data transmission network (22) to check whether there is an authorization to receive a control instruction, the location being adapted to carry out at least one of the functions of outputting and generating the control instruction.

38. A method in accordance with claim 37, the control instruction being generated such that it can only be used once.
